(19) United States
(12) Patent Application Publication
(10) Pub. No.: US 2009/0124263 A1
(43) Pub. Date: May 14, 2009

(54) Method of automatically establishing a telephone call connection on a cost-optimized basis

(76) Inventor: Reinhard Wirtl, Bad Zell (AT)

Correspondence Address: COLLARD & ROE, P.C., 1077 NORTHERN BOULEVARD, ROSLYN, NY, 11576, US

(21) Appl. No.: 12/006,213

(22) Filed: Dec. 31, 2007

(30) Foreign Application Priority Data
Nov. 9, 2007 (AT) A 1809/2007

(51) Int. Cl. H04Q 7/22

(52) U.S. Cl. 455/445

(57) ABSTRACT

The invention relates to a method of automatically establishing a telephone communication connection between a mobile telecommunication device and a called party on a cost-optimized basis, comprising at least a cellular mobile network (5) with a unique network code (15), at least a mobile station (2) which is connected to the mobile network (5) so as to communicate and which has its own stored network code, a communication network (6) which is connected at least via a gateway (8) and a direct link (7) to the mobile network (5) and at least one called party (3), and a check is run to ascertain whether the network code of the mobile station matches the network code of the mobile network and whether a portion of the identification code of the called party is stored in a communication route table.

Applicant claims priority under 35 U.S.C. §119 of AUSTRIAN Patent Application No. A 1809/2007 filed on Nov. 9, 2007.

### BACKGROUND OF THE INVENTION

1. Field of the Invention

The invention relates to a method of establishing a telecommunication connection between a mobile telecommunication device and a called party on a cost-optimized basis

2. Background Art

In order to establish a telecommunication connection, a unique identification code is transmitted from a calling station to a switching system, and the latter establishes a communication connection to the called party, which is on stand-by. Such communication systems have long been known from the prior art. As the telecommunications market has become increasingly liberalized, a number of network service providers have come into being, which usually have a totally different set of charges for the communication connections established or set up. A person making a mobile communication connection is therefore faced with the problem of choosing which network out of a plurality of possible connections will be most favorable for him in establishing a particular communication connection. In order to deal with this problem, systems for planning optimized communication connections are known from the prior art, in particular what are known as Least-Cost-Routers.

If the calling station is a mobile telephone, for example a GSM or 3G mobile telephone, in addition to choosing the most favorable network for establishing the link to the destination station, there is another variable to take into account because the mobile telephone is registered with a mobile network and charges may also be incurred for the mobile element of the link under certain circumstances.

In order to find the cheapest communication connection between a mobile telephone and a called party, patent specification DE 103 41 737 B4 discloses a method and a system of least-cost routing in a telecommunication system which is automated and specific to the user. The telecommunication system comprises at least one mobile network, at least one mobile station, and at least one landline network, and a so-called gateway is connected between the mobile network and the landline network in a communicating role. The document discloses a system whereby, after entering the destination call number of the called party in the mobile telephone, the destination call number is evaluated and either a direct dial connection is established to the destination call number or a code of one of several possible gateways is read out from a stored table, to which the mobile telephone can establish the cheapest connection in the mobile network to which it is currently logged-on. The called gateway accepts the incoming request to establish a connection and evaluates the transmitted destination call number. A call route table is also stored at the gateway, and the call control system at the gateway selects from the possible call connections the one via which the called party can be obtained most favorably. After establishing the call connection, the gateway couples the mobile telephone with the called party. It is also disclosed that the individual gateways are synchronized with the mobile telephones, thereby enabling the call route tables to be kept up to date.

Patent specification EP 1 207 702 A2 also discloses a system and a device for establishing a call, in particular with a view to improving a landline telephone so that the most favorable communication service providers are always selected for every outgoing call. To this end, the system is connected into the line connection between the called party and the network terminal, in particular the telecommunication junction box. When a request to establish a connection arrives, the system disconnects the telecommunication line, analyzes the destination call number of the called party and selects from stored call routes the call route that is the most suitable. To this end, the system selects a so-called network operator dial code and then dials the temporarily stored destination call number of the called party.

The disadvantages of the systems known from the prior art reside in the fact that it is necessary to gate a dialing unit into the telecommunication line, which firstly means additional expense and is only suitable for cable subscribers. Although the other known method is suitable for transmitting outgoing calls cheaply from a mobile telephone, it is necessary to provide a plurality of gateways and in addition, it is also necessary to store a call route table both on the mobile telephone and on the gateway, which must always be kept up to date to enable an optimized link to be established. If there is a large number of mobile telephones and a plurality of gateways, this involves a not inconsiderable degree of complexity in order to achieve synchronization and there is also a risk that individual components will not have up-to-date call route tables available. Another disadvantage is the fact that the gateway must always accept the incoming call in order to be able to evaluate the destination call number. Accepting this call necessarily means that a call connection incurring charges is established every time, without there being any certainty that the called party can be obtained. The user of the mobile telephone therefore incurs unavoidable costs with every attempt to make a call.

The advantage of modern GSM and 3G mobile telephones, however, is that mobile communications are also possible beyond the boundaries of the respective home network, in particular beyond national boundaries. However, mobile communication connections outside the home network are usually very expensive because the network charges are incurred from the respective foreign service provider (active and passive roaming). Especially in the case of telephone calls in a foreign network, in other words when the mobile telephone is logged into a foreign network, it is a particular disadvantage if a connection which incurs charges has to be established in order to find a cheapest communication route. Dialing directly from a foreign network also has disadvantages because the charges for outgoing calls are significantly higher than those for incoming (passive) communication connections.

### OBJECTIVES AND ADVANTAGES OF THE INVENTION

Accordingly, the objective of the invention is to propose a method and a telecommunication system for establishing a cost-optimized communication connection between a mobile telephone and a called party, which establishes an inexpensive communication connection both in the home network and in a foreign mobile network.

This objective is achieved by the invention on the basis of the method steps defined in claim 1. After entering or selecting a unique identification code of the desired called party from the mobile station and initiating a request to establish a connection, the procedure of establishing the connection and hence establishing the actual communication connection is run by the sequence control system provided on a mobile station specifically for this purpose. However, initiating a request to establish a connection may also be run as a separate event to enable a specific response to be generated, in particular with a view to departing from the standard procedure and running a specially adapted sequence control.

A primary objective of the method proposed by the invention is to ascertain whether the mobile station is currently logged into the home network or a foreign mobile network, because communication connections across a foreign mobile network are always associated with significantly higher costs. In order to identify a mobile network uniquely, each and every one has a network code that is unique worldwide, which is made up of a country code and an operator's code. To enable the mobile station to link up to a mobile network, a network code is stored in the mobile station. If the network code of the mobile station matches the network code of the mobile network, the mobile station is logged into the network of the mobile service provider, otherwise, the mobile station is logged into a foreign network and increased communication charges will be incurred. In the event of a match, what is known as the call-through method is run, and in the absence of a match, the communication-control system switches to the call-back method.

In the case of the call-through method, the mobile station is in the home network, in which case there will usually be particularly inexpensive communication connections to the communication network, and some destination call numbers can preferably be obtained without charges. To enable a decision as to whether the method proposed by the invention should be continued, it is necessary to ascertain which is the most favorable communication connection to the desired called party. A communication route table is stored on the mobile station, in particular on an application platform or in a memory module, in which it is laid down which called parties should be connected using the method proposed by the invention and which communication connections should be established via the standard communication route. To this end, at least the area code and if necessary a part of the subscriber code from the identification code are compared with entries in the communication route table. If a match can be found, the communication control system hands control of establishing the communication connection back to the sequence controller of the mobile station, which establishes the communication connection via the standard communication route.

If no match was found in the communication route table, a first communication connection, which is usually free of charge, is established with the gateway. The gateway accepts the incoming communication connection and then receives from the mobile station the identification code of the desired called party. The gateway maintains the first communication connection and establishes a second communication connection to the desired called party. The gateway then couples the first with the second communication connection and thus establishes a continuous communication connection from the mobile station to the called party.

In the case of the call-back method, the network code of the mobile station does not match that of the mobile network and the mobile station is therefore logged into a foreign mobile network. In order to reduce costs, what is of decisive importance in this instance is that an outgoing connection can not be made from the mobile station. The communication control system on the mobile station therefore issues a request to establish a connection to the gateway. With this request to establish a connection, the code of the calling mobile station is sent to the gateway without reaching the stage of establishing a communication connection.

The gateway extracts the code of the calling mobile station from the request to establish a connection, temporarily stores this code for a short time and terminates the communication connection.

Using the stored code of the mobile station, the gateway establishes the first communication connection with the mobile station. The communication control system on the mobile station waits for the return connection from the gateway, thus accepts the request to establish a connection and in turn transmits the identification code of the desired called party to the gateway.

The other method steps are the same as those of the call-through method, and in particular, the gateway establishes the second communication connection to the called party and couples the first and second communication connection.

In another embodiment, the mobile station has a man-machine interface, by means of which an identification code can be entered or an identification code can be selected from the stored identification codes. The advantage of this embodiment is that the user of the mobile station can store the unique identification codes of the plurality of communication partners in the mobile station and can therefore select them easily and quickly by means of a convenient user guide, without having to know the specific identification codes by heart.

It is of particular advantage if, after initiating the request to establish a connection, a communication control system is started up. In known mobile stations, in particular mobile telephones, the application platform would start up a communication control system after confirmation of the request to establish a communication connection, which would in turn set up the link via a high-frequency communications interface of the mobile part with the mobile called party of the mobile network. As a result of this advantageous embodiment, prior to establishing the communication connection, the communication control system is started up, in particular sequence instructions are loaded into the application platform, thereby enabling start-up and running without any action on the part of the user.

As defined in the claims, the communication control system is provided in the form of a software program which is run on an application platform of the mobile part. Since the other sequence controls needed to operate the mobile station correctly are also run on this application platform, a seamless integration of the communication control system in the operating control system of the mobile station is guaranteed. In this respect, it is of particular advantage that the identification code of the called party and selection of the appropriate communication connection are run in the background so that the user does not notice these procedures and in particular does not have to take any action.

In other advantageous embodiments, the application platform is provided in the form of the Symbian or Windows Mobile operating system, for example. The advantage of these embodiments is that these operating systems are used particularly widely, thereby guaranteeing reliable operating and seamless integration of the communication control system due to the high degree of standardization of the interfaces available. Another advantage is that these operating systems offer very flexible access to the communication control systems specific to mobile network applications and thus enable an optimum selection of the communication connection irrespective of the mobile network onto which the mobile part is logged.

A particularly practical advantage can be obtained in terms of user-friendliness if the communication control system and the communication route table can be transmitted across the cellular mobile network to the mobile station. In order to activate the communication route optimization function, it is therefore not necessary for the user to present the mobile station at a representation point of the service provider in order to run the communication control system and the communication route table on the application platform or store them in a memory means of the mobile station. Advantageously, the user can decide to activate the optimized communication route planning function for his mobile station at any time and the corresponding components will automatically be transmitted to his mobile station where it will preferably be stored in a memory module, without any action on his part.

The method proposed by the invention includes a step whereby a direct communication connection is established between the mobile station and the called party. With this embodiment, as defined in the claim, when a direct communication connection is established, the communication control system is inactive, which means that it is only the sequence control system of the mobile station which establishes the connection.

Another particular advantage of this embodiment is that the user has the option of deliberately deactivating the communication control system and thus using the mobile station exclusively with the basic functions, without the communication control system of the mobile station being affected by the stored communication control system.

One embodiment in which the identification code is transmitted to the gateway by multi-frequency dialing advantageously ensures that this method step does not require any additional or separate components on the mobile station, which means that this multi-frequency dialing can be run by means of a standard, readily available multi-frequency generator, in particular a DTMF multi-frequency generator. DTMF multi-frequency dialing is widely used, standardized and enables the identification code to be transmitted safely and reliably.

In order to make the method proposed by the invention user-friendly and gain acceptance, is it of decisive importance for the identification code to be transmitted without the interaction of the user and without the knowledge of the user. One particular advantage of the method proposed by the invention is that the user does not have to change his usual telephone behavior because the method proposed by the invention runs all the steps necessary to find the cheapest communication connection for him in the background and without the knowledge or interaction of the user.

In one embodiment, the gateway establishes the second communication connection by means of a switching system of the communication network. The gateway is connected to the communication network by means of at least one communication route, receives the identification code of the called party and then establishes the connection via the switching system of the communication network. If a connection to the called party is successfully established, the first communication connection is coupled with the second communication connection and a communication connection is thus established between the mobile station and the called party.

Logging the established communication connections by means of a data logging module at the gateway offers an advantage in that the respective connection parameters can be subsequently verified from the logged communication connections. This is of particular advantage if, at a later point in time, for example in the event of a dispute, evidence has to be provided of a communication connection that was established via the gateway. With respect to telecommunication guidelines, this embodiment is also of advantage because the operator of the gateway and the communication service proposed by the invention will be required to keep logs of communication connections for a prescribed period of time.

An embodiment which is of particular advantage is one in which information relating to charges can be generated from the recorded call data, because this means that the charges incurred for call links can be derived directly from the call data without the need for additional method steps. The user of the mobile station is provided with the cheapest communication connection for every outgoing connection and the costs incurred for establishing the first and/or second communication connection are determined from the call data and periodically invoiced to the user.

In the case of another embodiment, the communication charge data is transmitted to a control and evaluation unit. The advantage of this is that the user has simple access at any time to the communication charges incurred, thereby enabling the logged calls to be checked particularly easily. For example, this enables precautions to be taken to prevent the user from being alarmed by keeping the user informed about excessively high communication charges.

It is of particular advantage if a control and evaluation unit is used to store a plurality of communication route tables so that a selected communication route table can be transmitted via the mobile network to the mobile station if necessary or on request. Since the telecommunications market became more liberal, a large number of different mobile network operators have come into being, some of which levy significantly different charges for the individual communication routes. This huge choice is exacerbated by the possibility of using mobile communications outside the home network and also due to the fact that the call charge information for the individual communication routes changes in quick cycles. From the point of view of the service provider of the method proposed by the invention, the communication route tables will therefore be permanently updated and will be updated with respect to their relevance to the user of a mobile station, in particular depending on the respective contract data of the user with the mobile network operator.

Again in terms of making the method as simple as possible to use, and in particular the fact that the user is not required to take any complex action, one embodiment defined in the claims has a specific advantage in that the updated communication route tables are transmitted to the mobile station in the background, so that user can be sure that he will always have an up-to-date communication route table and calls can therefore always be connected across the cheapest communication connection.

A particularly advantageous embodiment is one whereby, if the user has an interface on the control and evaluation unit, he can access the stored communication route tables and edit them. For every user, in particular for every mobile station, when the method proposed by the invention is switched on or activated, at least one specific communication route table is provided, in which entries previously stored as defaults serving as decision-making criteria for the communication route to be selected are stored. Since the user may have entered into a special agreement with the mobile network operator, but the operator of the method proposed by the invention can not know about these special agreements, it is of particular advantage if the user is free to edit or configure the communication route table and hence the decision-making criteria for the automatic selection of the cheapest communication route.

In one embodiment, a request can be made for the communication route table to be transmitted from the mobile station. The advantage of this embodiment is that transmission of the communication route table from the mobile station can be postponed, and in particular, the user can initiate the transmission, which means that the timing of the transmission can be defined. A data transmission across a mobile network, in particular across a foreign mobile network, is usually very expensive. Making it possible to set the specific time at which the communication route table will be transmitted ensures that the transmission takes place only at the cheaper data charge of the home network.

To enable the user to be informed by the service provider of an update of the communication route table, a short message can be sent to the mobile station, for example, asking the user to download the updated communication route table from the control and evaluation unit. Again in this situation, the user is free to decide at what time he wishes to update the communication route table.

A particular advantage is gained by one claimed embodiment in which the code of the mobile station is transmitted to the gateway by means of signaling information, and in particular a communication connection that would incur charges is not established. If the mobile station is logged into a foreign network, high costs are incurred for all communication connections and in particular, outgoing communication connections are more expensive than incoming connections. The advantage of the claimed embodiment is that a communication connection to a desired called party can be established via the gateway, and the first communication connection from the gateway to the mobile station is established, for which the user will incur the much cheaper passive connection charges. Again in this situation, the user does not have to undertake any complex actions to establish a communication connection because transmission of the code to the gateway and acceptance of the arriving, incoming communication connection is run by the communication control system in the background. This ensures that even if a communication is connected from a foreign mobile network, the cheapest communication connection is always selected, without the user having to do anything.

In accordance with the known 2G and 3G mobile standard, the identification code of the calling mobile station is transmitted in the request to establish a connection when a communication connection is being connected, and in particular this will be the call number of the mobile station. The user can now deliberately opt to suppress transmission of this number or this code will not be transmitted in certain mobile networks. Another particular advantage of this claimed embodiment is that the code of the mobile station also contains a unique code which is transmitted with the request to establish a connection and which can not be suppressed by the user. This being the case, the calling mobile station can always be identified by the gateway, whatever the circumstances.

Another claimed embodiment, in which a communication control system at the gateway extracts the code of the mobile station from an incoming request to establish a connection and then declines the connection, ensures that if a request to establish a call comes in from a foreign mobile network, an active communication connection can proceed.

Another claimed embodiment where the gateway establishes the first communication connection to the mobile station via a switching system of the mobile network ensures that if a request to establish a connection comes in from a foreign mobile network, the method proposed by the invention will establish a passive communication connection to the mobile station, which will result in significantly cheaper passive call charges for the user.

Another particularly advantageous embodiment is one whereby the switch control system accesses different areas in the communication route table irrespective of the network code of the mobile station. A mobile station, in particular a mobile telephone, is authorized for a communication mode due to a communicating connection of a network operator identification device or so-called SIM card. The mobile station is therefore configured to be able to establish a connection to the home network of the mobile network operator, and to a number of partner networks. The technical features for establishing or processing a communication connection are fully integrated in the mobile station and the access configurations for establishing a communication connection to the mobile network are stored on the SIM card. The user may therefore have a number of different SIM cards, in which case he will have a designated home network of every network operator. This is of particular advantage for people who travel frequently and have SIM cards for a number of different mobile network operators in different countries.

Another claimed embodiment ensures that the communication control system evaluates the network code of the currently active SIM card and then accesses the decision-making rules and communication connections in the communication route table valid for this network code. With this embodiment, this specifically means that the communication control system on the mobile station has a plurality of different set network codes for an inserted or registered SIM card, each of which selects the most favorable communication connection without the user having to update or reload the communication route table.

The objective of the invention is also achieved as defined in claim 20 by means of a telecommunication system for running the method proposed by the invention.

If, as claimed, a coupling network is provided in the gateway, the gateway can advantageously connect the first and second communication connection to one another and thus establish a continuous communication connection from the mobile station to the called party without having to provide additional equipment for this purpose.

In another advantageous embodiment, the gateway has a called party with a unique identification code. This embodiment ensures that the gateway can be reached via the switching point of the mobile network by means of standardized and known communication connection methods, and in particular that the gateway behaves like a known called party. This also ensures that the method proposed by the invention, in particular the communication control system on the mobile station, is able to access standard components of the mobile station in order to establish a communication connection to the gateway, which means that the communication control system can be run on the overriding majority of mobile stations.

In one embodiment, the mobile station has a coupling device for a SIM card, and a network code is stored in the SIM card. As a result of this embodiment, the technical device or systems needed to establish or process a communication connection via a mobile network are separate from the authorization system for establishing such a communication connection. In particular, this embodiment ensures that a mobile station is able to establish communication connections with a plurality of mobile network operators, but the communication control system and the communication route table are separate from the respectively inserted or coupled SIM card and always co-operate with the technical device of the mobile element.

If the communication route table is based on a hierarchical structure, it is possible to keep parameters relevant to calls as well as decision-making rules and communication routes separate in a simple and reliable manner. In particular, a hierarchical structure offers a particular advantage in that the relevant decision-making rules are quick and easy to find because there is no need to search through the entire communication route table, which results in a considerable increase in speed, especially in the case of an extensive communication route table, thereby enabling calls to be connected rapidly, which in turn is of practical advantage in terms of gaining acceptance for the method.

It is of particular advantage if the hierarchical structure is organized on the basis of at least one network code. Since the communication control system and the communication route table are provided on the application platform or in the data memory of the mobile station and it would therefore be necessary to search through the table based on the network code of the mobile station for relevant entries, it is of particular advantage if all of the parameters which are irrelevant to the current network code as well as the communication routes are automatically left out of account when the hierarchical structure relating to the network code is selected. Accordingly, this embodiment ensures a safe and reliable separation of the parameters and communication routes according to the network code, which in turn advantageously ensures a quick communication connection.

### BRIEF DESCRIPTION OF THE DRAWINGS

The invention will be explained in more detail below with reference to examples of embodiments illustrated in the appended drawings. Of these:

FIG. 1 illustrates a telecommunication system for implementing the method proposed by the invention;

FIG. 2 is a flow chart of the method proposed by the invention.

### DETAILED DESCRIPTION OF PREFERRED EMBODIMENTS

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

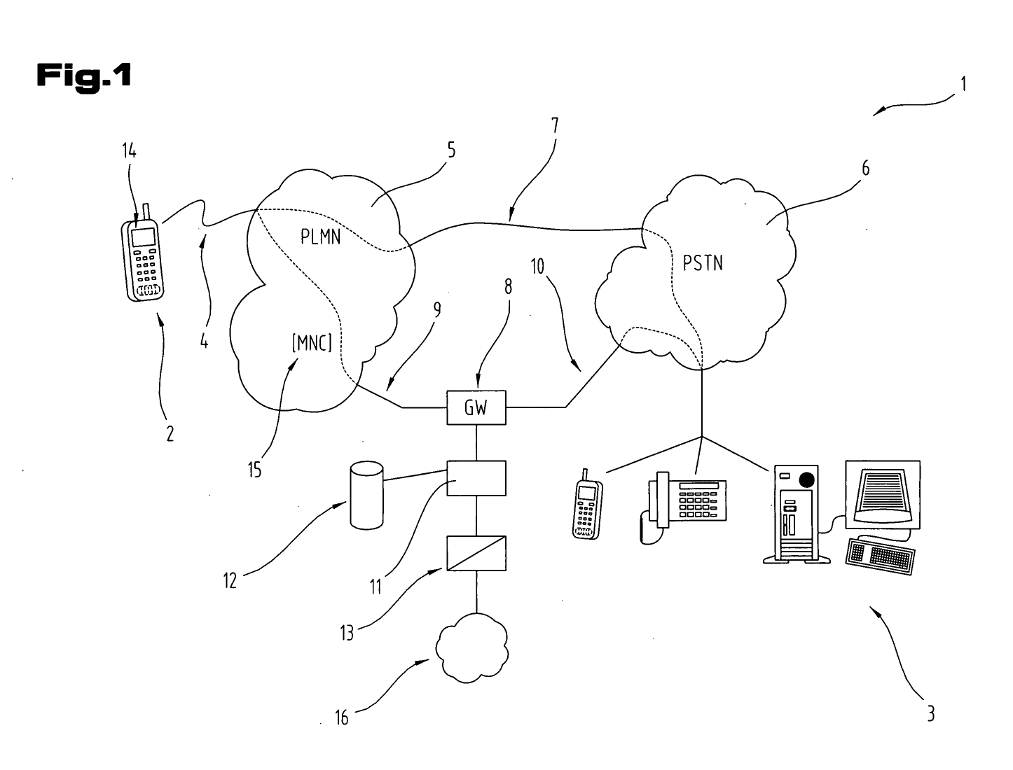

FIG. 1 illustrates a telecommunication system 1 designed for automatically establishing a communication connection between a mobile station 2 and a called party 3 on an optimized cost basis. The mobile station 2 is connected via a mobile link 4 to a cellular mobile network 5 and the called party 3 is also connected to a communication network 6, and a direct communication connection 7 exists between the mobile network 5 and the communication network 6. A gateway 8 is also disposed between the mobile network 5 and the communication network 6, which is connected via a first 9 and second 10 communication connection to the mobile network and the communication network. The gateway 8 is also connected to a control and evaluation unit 11 and a plurality of communication route tables are stored in this unit, in particular in a data memory module 12. The control and evaluation unit 11 is connected to a data network 14 via an interface 13, thereby enabling the user to access the stored communication route tables.

The mobile station 2 has a man-machine interface 14, which may be provided in the form of a key pad, a display and a user interface, for example, and by means of or with which the user can select or enter the unique identification code of the called party 3. Basically, a mobile station may comprise two components, and one component implements the technical procedure of making a communication connection via a mobile radio channel and a second component provides the communication parameters as well as the access and authorization data for coupling into the mobile network. The technical communication module of a mobile station has an international unique device identification code, the so-called IMEI. The network access module is preferably provided in the form of a SIM card and stores a network code (MNC) of the mobile network operator. Every mobile network which conforms to the 2G or 3G mobile standard also stores a network code. Accordingly, the so-called home network is the mobile network in which the network code 15 matches the network code stored in the mobile station. When the mobile station is logged into a mobile network in which the network codes do not match, additional mobile charges will be levied, known as roaming charges.

The communication network 6 comprises a known switch-based communication network, and the called party 3 may be a mobile station which is registered in a different mobile network, a landline telephone system and a data terminal unit. The called party has a unique identification code (SID) comprising an area code (AC) and a subscriber code (SC). By means of this identification code, the communication network 6 is able to determine the communication route to the called party and establish the communication connection.

The gateway 8 also has such a unique identification code, because it must be accessible from the mobile station 2 via a switching system of the mobile network 5. Also at the gateway 8, a log is kept of the established communication connections, and it is from this logged data that the communication charges to be paid by the user are determined. The communication data and the communication charge information are transmitted to the control and evaluation unit 11 and forwarded from there to a billing system of the service provider, for example. Another function of the control and evaluation unit is to transmit the stored communication route tables and the communication control system on request by the mobile station 2 via the mobile network 5 to the mobile station. The control and evaluation unit 11 is connected to a data network 16 via an interface 13, by means of which the user, once authenticated, has access to the communication route tables relevant to him and can specifically edit and update these. The data network 16 is preferably the Internet, the specific advantage of which is that the requisite communication systems are widely used, thereby obviating the need for additional communications equipment.

When the method proposed by the invention is initiated or activated, an activation code is sent from the control and evaluation unit 11 via the mobile network 5 to the mobile station 2. This activation code contains information, such as how the communication control table and the communication route table are to be transmitted to the mobile station. By preference, the activation code is transmitted to the mobile station in the form of a short message, what is known as an SMS, and the short message contains a reference to the control and evaluation unit. The user can then deliberately activate this reference, for example to make use of a favorable download tariff, prompting the sequence control system of the mobile station to request the transmission of the communication control table and the communication route table, which are preferably transmitted by means of WAP-Push.

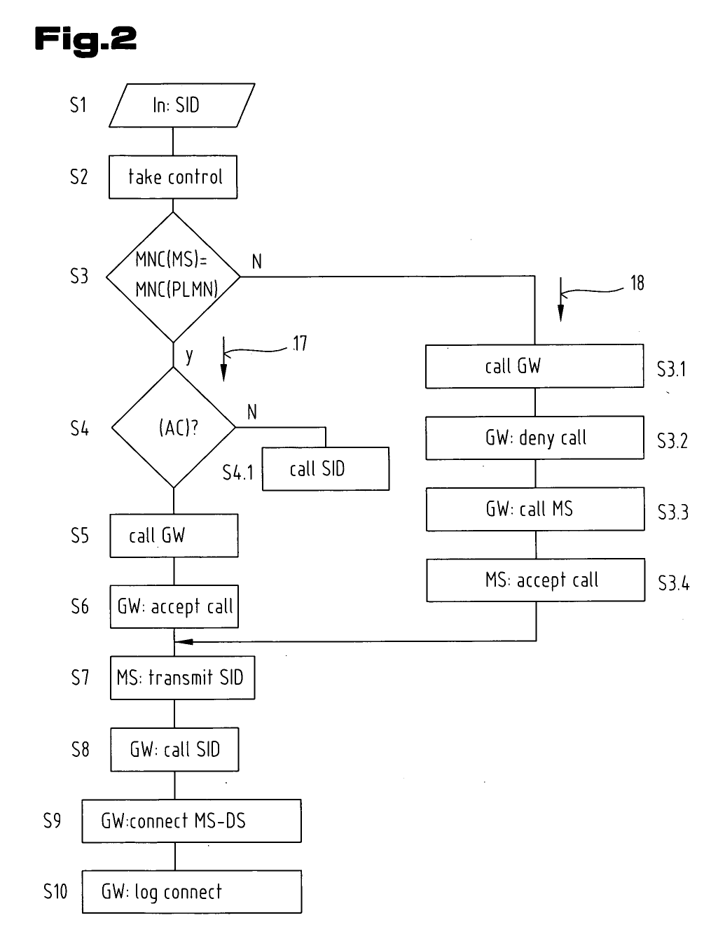

FIG. 2 is a flow chart illustrating the method proposed by the invention, in which some of the illustrated method steps are run not on the mobile station but at the gateway. This is indicated by the prefix GW.

At step S1, the user selects the identification code (SID) of the desired called party and enters it in the mobile station via an input system. Entering the full identification code initiates the procedures involved in establishing a communication connection to the called party. In the case of a mobile telephone, this request to establish a connection is initiated by operating the connect button.

In step S2, this event is detected by the communication control system, which assumes control of the rest of the communication connection. Since the communication control system is run on an application platform on the mobile station, it is fully integrated in the sequence controller of the mobile station and is therefore able to access all the essential components of the mobile station via existing interfaces.

In a first step (S3), the communication control system ascertains whether the mobile station is logged into its own or a foreign mobile network. To this end, the network code (MNC) of the mobile station is compared with the network code of the mobile network (PLMN). If the two codes match, the mobile station is registered in the home network and a so-called call-through method 17 is then run. However, if the two codes do not match, the mobile station is logged into a foreign mobile network, in which case a so-called call-back method 18 is run.

The first step (S4) of the call-through method 17 is to ascertain which is the most favorable communication connection to the desired called party. Due to relentless competition, virtually every mobile network operator offers a plurality of different tariffs, and there are a number of differently charged communication routes for every tariff. In particular, it is common for one or more groups of called parties to be obtainable via a free or extremely cheap communication connection within every contract. In order to determine the respective communication route charge, the area code (AC) and optionally a section of the subscriber code (SC) is extracted from the identification code (SID) and compared with the entries of the communication route table. If the communication route table contains no entry for the extracted code, this means that there is no cheaper communication route available for this communication connection to be established and a direct communication connection can therefore be established.

In order to establish a direct communication connection (S4.1), the communication control system halts processing and hands the sequence control back to the control module of the mobile station, which establishes the communication connection in the prescribed manner.

If an entry for the called party to be dialed was found in the communication route table, a connection to the gateway is established in the next step (S5), whereby the latter is called by means of its own unique identification code.

The gateway accepts the incoming request to establish a connection (S6) and thus establishes a communication connection between the mobile station and the gateway. Since the gateway can usually be accessed via a communication route that is free of charge, no charges are incurred in spite of a communication connection having been established.

Once the communication connection has been established, the identification code of the called party is transmitted to the gateway (S7) by the mobile station using multi-frequency dialing, and in particular the code is transmitted by means of DTMF. The gateway accepts the transmitted identification code and in turn establishes a second communication connection to the called party (S8).

Once the second communication connection (S9) has been established, the gateway connects the first and the second communication connection, and hence connects the mobile station to the called party.

communication parameters such as the duration of the conversation and the identification code of the called party are also detected and logged (S10). The call charge information for billing the call charges to the user is taken from this communication data.

In the case of the so-called call-back method 18, other requirements must be satisfied. Since the mobile station is logged into a foreign mobile network in this instance, significantly higher costs will immediately be incurred for every communication connection made, and incoming communication connections will be significantly cheaper than outgoing ones. In order to secure an advantage by saving costs and at the same time avoid restricting convenience for the user, the intention is therefore to divert an outgoing connection into an incoming connection, without requiring any interaction on the part of the user and without this diversion making it any more complicated to make calls than usual.

In the first step (S3.1), therefore, the gateway is called by the mobile station. The call number is transmitted so that the gateway detects the identification code of the calling mobile station, extracts this code and declines the communication connect function (S3.2) so that no communication connection is made.

In the next step (S3.3), the gateway establishes the first communication connection to the mobile station and the communication control system on the mobile station accepts the anticipated incoming call (S3.4). A call connection has now been established between the mobile station and the gateway, by means of which the identification code of the called party is transmitted (S7). The following method steps are identical to those of the call-through method 17.

The embodiments illustrated as examples represent possible design variants of the method and it should be pointed out at this stage that the invention is not specifically limited to the design variants specifically illustrated, and instead, the individual design variants may be used indifferent combinations with one another and these possible variations lie within the reach of the person skilled in this technical field, given the disclosed technical teaching. Accordingly, all conceivable details of the design variants described and illustrated are possible and fall within the scope of the invention.

For the sake of good order, finally, it should be pointed out that, in order to provide a clearer understanding of the structure of the telecommunication system, it and its constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1 and 2 constitute independent solutions proposed by the invention in their own right. The objectives of the invention and associated solutions may be found in the detailed description of these drawings.

### LIST OF REFERENCE NUMBERS

1 Telecommunication system
2 Mobile station (MS)
3 Called party
4 Radio link
5 Cellular mobile network (PLMN)
6 Communication network (PSTN)
7 Direct communication connection
8 Gateway (GW)
9 First communication connection
10 Second communication connection
11 Control and evaluation unit
12 Data logging and memory module
13 Interface
14 Man-machine interface (MMI)
15 Network code (MNC)
16 Data network
17 Call-back
18 Call-through

1. Method of automatically establishing a telecommunication connection between a mobile telecommunication device and a called party on a cost-optimized basis, comprising at least
a cellular mobile network with a unique network code,
at least one mobile station, which is connected to the mobile network so that it is able to communicate and which has its own stored network code,
a communication network, which is connected by means of at least one gateway and has a direct connection to the mobile network, and at least one called party,
comprising the following steps
entering or selecting a unique identification code of the desired called party from the mobile station and initiating a request to establish a connection
checking whether the network code of the mobile station matches the network code of the mobile network if a match exists:
checking whether a portion of the identification code is stored in a communication route table if not:
establishing a direct communication connection between the mobile station and the called party
if so:
establishing a first communication connection from the mobile station to the gateway
transmitting the identification code of the called party to the gateway
establishing a second communication connection from the gateway to the called party
coupling the first and second communication connection in the gateway
if a match does not exist:
initiating a request to establish a communication connection from the mobile station to the gateway
extraction of a code of the calling mobile station by the gateway
termination of the communication connection request by the gateway
establishing a first communication connection from the gateway to the mobile station
transmitting the identification code of the called party from the mobile station to the gateway
establishing a second communication connection from the gateway to the called party
coupling the first and second communication connection in the gateway.

2. Method according to claim 1, wherein the mobile station has a man-machine interface enabling the identification code of the called party to be entered or an identification code to be selected from a stored plurality of identification codes.

3. Method according to claim 1, wherein, when the request to establish a connection is initiated, a communication control system is started up.

4. Method according to claim 3, wherein the communication control system is provided in the form of a software program which is run on an application platform of the mobile station.

5. Method according to claim 3, wherein the communication control system and the communication route table are transmitted via the cellular mobile network to the mobile station.

6. Method according to claim 1, wherein, in order to establish a direct communication connection, the communication control system hands the sequence controller over to the application platform of the mobile station.

7. Method according to claim 1, wherein the identification code is transmitted to the gateway by multi-frequency dialing.

8. Method according to claim 1, wherein the communication control system transmits the identification code to the gateway.

9. Method according to claim 1, wherein the gateway establishes the second communication connection via a switching system of the communication network.

10. Method according to claim 1, wherein a data logging module is provided at the gateway, which keeps a log of the established communication connections.

11. Method according to claim 10, wherein charge information is generated from the logged communication data.

12. Method according to claim 10, wherein the charge information is transmitted to a control and evaluation unit.

13. Method according to claim 1, wherein the control and evaluation unit stores a plurality of communication route tables and, if necessary or on request, a selected communication route table is transmitted via the mobile network to the mobile station.

14. Method according to claim 1, wherein the user is able to access the communication route tables stored in the control and evaluation unit via an interface and edit them.

15. Method according to claim 1, wherein a transmission of the communication route table is requested by the mobile station.

16. Method according to claim 1, wherein the code of the mobile station is transmitted to the gateway by means of signaling information.

17. Method according to claim 16, wherein a communication control system at the gateway extracts the code of the mobile station from an incoming request to establish a connection and declines the request for a connection.

18. Method according to claim 16, wherein the gateway establishes the first communication connection via a switching system of the mobile network to the mobile station.

19. Method according to claim 1, wherein the switch control system accesses different areas in the communication route table depending on the network code of the mobile station.

20. Telecommunication system for implementing the method according to claim 1,
comprising
a mobile station with a unique device code, an application platform and a data memory,
a mobile network, which is designed to establish a communication link (4) to the mobile station,
a gateway, which has a communication link to the mobile network and to a communication network
and a called party with a unique identification code,
whereby
a communication control system and a communication route table are stored on the application platform or in the data memory, and a communication control system is provided at the gateway.

21. Telecommunication system according to claim 20, wherein a coupling network is provided in the gateway.

22. Telecommunication system according to claim 20, wherein the gateway has a called party with a unique identification code.

23. Telecommunication system according to claim 20, wherein the mobile station has a coupling device for a SIM card, and a network code is stored in the SIM card.

24. Telecommunication system according to claim 20, wherein the communication route table is based on a hierarchical structure.

25. Telecommunication system according to claim 24, wherein the hierarchical structure is organized according to at least a network code.
